(19) United States
(12) Patent Application Publication
(10) Pub. No.: US 2002/0069731 A1
(43) Pub. Date: Jun. 13, 2002

(54) Vibration dampening apparatus

(76) Inventor: Alan J. Soucy, Georgetown, MA (US)

Correspondence Address: TESTA, HURWITZ & THIBEAULT, LLP, HIGH STREET TOWER, 125 HIGH STREET, BOSTON, MA, 02110, US

(21) Appl. No.: 09/953,030

(22) Filed: Sep. 14, 2001

Related U.S. Application Data
(60) Provisional application No. 60/232,542, filed on Sep. 14, 2000.

(51) Int. Cl. B23B 25/00; B23B 3/00

(52) U.S. Cl. 82/163; 82/173

(57) ABSTRACT

Disclosed are apparatus and methods used to reduce or eliminate vibration during material removal processes, such as high-speed machining. The apparatus and method are particularly useful in the machining of thin-wall or oddly-shaped structures. The apparatus includes a self-contained flexible, expandable bladder, which is surrounded by a gel-like material which is in turn enclosed in a flexible, expandable bag-like enclosure. The flexible bag material provides structural support to prevent disturbance of the work piece when influenced by material removal forces. The bladder is capable of expanding and contracting within the enclosure. The expansion of the bladder displaces the gel-like material and expands the bag-like enclosure, thereby ensuring adequate contact between the bag-like enclosure and both the holding fixture and the work piece.

### CROSS-REFERENCE TO RELATED APPLICATIONS

This application incorporates by reference, and claims priority to and the benefit of, U.S. Provisional Patent Application serial No. 60/232,542, which was filed on Sep. 14, 2000.

### TECHNICAL FIELD

The present invention relates to apparatus and methods for dampening vibrations. In particular, the present invention relates to apparatus for adjustably dampening vibrations in high-speed machining such as milling operations.

### BACKGROUND INFORMATION

There are several problems inherent with current work holding techniques for dampening vibration during machining. Current solutions include backfilling a work piece with conformal materials such as dense foams or clay materials. These solutions have inherent shortcomings as the materials can change dampening characteristics, change properties, or rapidly decay upon contact with the coolants used in the material removal processes. Other problems typically encountered are the uncontrollable distortion of the work piece, as well as contamination of coolant sumps. A significant problem encountered with current work holding techniques is a phenomenon known as “chatter.” When a work piece is held in such a manner that all surfaces are not adequately constrained, the work piece can vibrate or resonate during machining. Chatter can be a function of tool geometry, work piece and tool materials, and cutting conditions, such as cutting speed, depth of cut, and feed rate. Chatter results in poor surface finishes and inaccuracies in component tolerances. Chatter also prevents machine tools from operating at their optimum material removal rates, thereby resulting in reduced productivity. Chatter can also lead to premature tool wear and breakage, especially with ceramic cutters. One purported solution for reducing chatter can be found in U.S. Pat. No. 5,680,801, which is hereby incorporated by reference in its entirety.

### SUMMARY OF THE INVENTION

The invention is drawn to an apparatus used to reduce or eliminate vibration during material removal processes, such as high-speed machining. The invention is particularly useful in the machining of thin-wall or oddly-shaped structures. The invention is effective in a variety of situations, such as where large surface area contact between the work piece and fixture is difficult or impossible to achieve using traditional work holding methods.

In one aspect, the invention relates to an apparatus for dampening vibrations. The apparatus includes an enclosure containing a gel-like material and a bladder disposed within the enclosure. In another aspect, the invention relates to a multi-compartment apparatus for dampening vibrations. The apparatus includes an enclosure including at least two compartments, wherein each compartment contains a gel-like material, and a bladder disposed within each of the at least two compartments of the enclosure.

Various embodiments of the foregoing aspects include an expandable bladder and an inflation assembly in fluid communication with the bladder. The expansion assembly includes a pressure indicator. In further embodiments, the enclosure is made of a flexible material and is configured to fit within a machining fixture. The enclosure shape can be polygonal, arcuate, tubular, and/or combinations thereof. In other embodiments, the bladder shape can be X-like, Y-like, T-like, V-like, rectangular, circular, annular, and/or combinations thereof. The gel-like material can be propylene glycol, hydrogel, plasticized polyvinyl chloride, superabsorbant polymer compositions, polyacrylamide, polyols, gelatin, and/or combinations thereof.

In yet another aspect, the invention relates to a method of attenuating vibration. The method includes the steps of disposing a vibration dampening apparatus in a fixture, disposing a work piece on the fixture, and biasing the apparatus against at least a portion of one of the work piece and the fixture to change the frequency characteristics thereof. In one embodiment, the vibration dampening apparatus includes an enclosure containing a gel-like material and a bladder disposed within the enclosure. In another embodiment of the method, biasing the apparatus includes expanding and/or contracting the bladder to alter the enclosure's size and/or shape, thereby facilitating contact of the apparatus with the fixture and the work piece. In other embodiments, the apparatus may include an expansion assembly including a pressure indicator in fluid communication with the bladder, the enclosure shape can be polygonal, arcuate, tubular, and/or combinations thereof, the bladder shape can be X-like, Y-like, T-like, V-like, rectangular, circular, and/or combinations thereof, and the gel-like material can be propylene glycol, hydrogel, plasticized polyvinyl chloride, superabsorbant polymer compositions, polyacrylamide, polyols, gelatin, and/or combinations thereof.

These and other objects, along with advantages and features of the present invention herein disclosed, will become apparent through reference to the following description, the accompanying drawings, and the claims. For example, the invention is scaleable and practical for use in the machining industry as well as other material removal and forming industries. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a schematic representation of one embodiment of a vibration dampening apparatus in accordance with the invention;

FIG. 2 is a schematic side view of a flexible bag-like enclosure of the apparatus of FIG. 1;

FIG. 3 is a schematic cross-sectional view of one embodiment of a bladder in accordance with the invention;

FIGS. 4A-4E are schematic representations of various embodiments of vibration dampening apparatus in accordance with the invention;

FIG. 5 is a schematic representation of a machining fixture with the vibration dampening apparatus of FIG. 1 installed;

FIG. 6 is a schematic side view of the fixture of FIG. 5;

FIG. 7 is a schematic representation of another machining fixture with two vibration dampening apparatus in accordance with the invention installed; and

FIG. 8 is a schematic representation of yet another machining fixture with another embodiment of a vibration dampening apparatus in accordance with the invention installed.

### DESCRIPTION

Embodiments of the present invention are described below. It is, however, expressly noted that the present invention is not limited to these embodiments, but rather the intention is that modifications that are apparent to the person skilled in the art are also included. In particular, the present invention is not intended to be limited to apparatus for dampening vibrations in high-speed machining.

Generally, the invention relates to a self-contained flexible, expandable bladder, which is surrounded by a gel-like material, which is in turn enclosed in a flexible, expandable bag-like enclosure. The flexible bag material provides structural support to prevent disturbance of the work piece when influenced by material removal forces. The bladder is capable of expanding and contracting within the enclosure. The expansion of the bladder displaces the gel-like substance and expands the bag-like enclosure, thereby ensuring adequate contact between the bag-like enclosure and both the holding fixture and the work piece. These contact interfaces provide sufficient force between the work piece and fixture in order to provide uniform contact characteristics. The gel-like substance, combined with the bladder, couples the work piece to the fixture, thereby providing vibration-canceling affects. This affords work piece stability and elimination of chatter during the material removal process. The volume of the expandable bladder and/or the gel-like material can be varied via a pump system in order to act as an active or variable vibration damping system. Alternatively, the enclosure can be disposed within a tube to facilitate use in lathe turning operations.

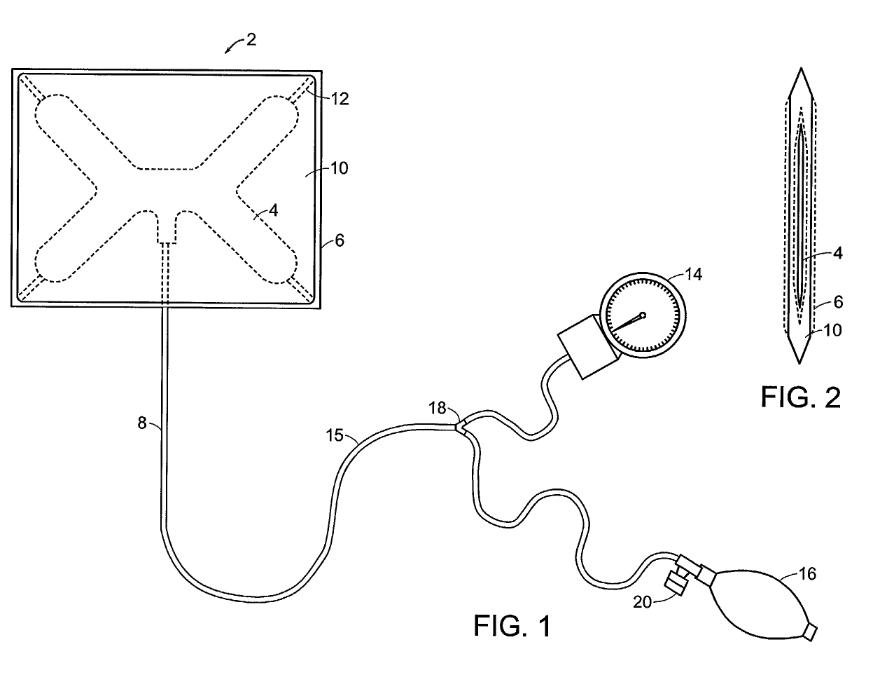

One embodiment of the present invention is illustrated in FIG. 1. The apparatus 2 includes a bladder 4 located within a bag-like enclosure 6. The bladder 4 is secured within the enclosure 6 using anchors 12 or other restraints to maintain the bladder 4 generally centered in the enclosure 6. The anchoring of the bladder can be achieved by using commercially available hardware or by adhesive, thermal, or chemical bonding. Alternatively, the bladder 4 can freely float within the enclosure 6. The enclosure 6 is filled with a gel-like material 10, or other suitable damping material, for example, propylene glycol, highly plasticized polyvinyl chloride, hydrogel, etc., although, any generally viscous material may be employed. The actual viscosity index of the gel-like material can vary to suit a particular application. Other suitable materials will be apparent to those skilled in the art, examples of which can be found in U.S. Pat. Nos. 5,843,145, 6,017,606, and 6,099,555, the disclosures of which are hereby incorporated herein in their entireties.

The apparatus 2 may also include an expansion assembly 15 coupled to the bladder 4 for adjustably expanding and contracting the bladder 4. The expansion assembly 15 includes a squeeze-bulb 16 or other suitable expansion device to supply a pressurized fluid to the bladder 4, a release valve 20 for contracting the bladder 4, and a tube 8 for connecting the squeeze-bulb 16 to the bladder 4. Alternatively, the expansion device could be any type of pump assembly, such as a motorized pump, a foot pump, any type of hand pump, or other source of compressed air. Further, the fluid used in the expandable bladder is typically air; however, any fluid would suffice, such as water, oil, or other gaseous materials. Because the bladder 4 should be contractible as well as expandable in order to be practical, a release valve 20 is provided. By opening the release valve 20, for example by either turning a handle or depressing button, the bladder 4 is contracted.

The tube 8 conveys the air, or other pressurizing fluid, from the squeeze-bulb 16 to the bladder 4. Pressurization can be monitored by a pressure indicator 14 or other suitable measurement device. The tube 8 may include a connection 18 for attaching the pressure indicator 14. Possible pressure indicators 14 include, for example, a pressure gauge, transducer, or any other known pressure measurement device. The connection 18 may be virtually any known type of tube fitting.

The enclosure 6 shown in FIGS. 1 and 2 has a rectangular shape, however, the enclosure 6 could be virtually any shape to suit a particular application. For example, the enclosure 6 could be polygonal, arcuate, tubular, or any combination of shapes. In the present application, the term polygonal is used to denote any shape including at least two line segments, such as rectangles, trapezoids, triangles, etc. The enclosure 6 is capable of expanding and contracting in response to expansion and contraction of the bladder 4. The enclosure 6 dimensions and materials will vary to suit a particular application.

Generally, the enclosure material should be resistant to coolant and other cutting fluids, as well as be relatively tough, to prevent accidental puncture and leakage. The enclosure material could be any suitable polymeric material or combination of polymeric materials, either with or without reinforcement. Suitable materials include: vinyl; polyurethanes, such as a thermoplastic polyurethane (TPU); ethylene vinyl acetate (EVA); thermoplastic polyether block amides, such as the Pebax® brand sold by Elf Atochem; thermoplastic polyester elastomers, such as the Hytrel® brand sold by DuPont; polyamides, such as a nylon, which may include 10 to 30 percent or more glass fiber reinforcement; silicones; polyethylenes; and equivalent materials. Reinforcement, if used, may be by inclusion of glass or carbon graphite fibers or para-aramid fibers, such as the Kevlar® brand sold by DuPont, or other similar method. Also, the polymeric materials may be used in combination with other materials, for example rubber. The material could also be a fluid-impervious textile or natural or synthetic rubber. Other suitable materials will be apparent to those skilled in the art.

The enclosure 6 can be any suitable size. In one embodiment, the enclosure 6 has a length of about 7.0 inches, a height of about 5.5 inches, a nominal width of about 0.5 inches, which can be increased to about 0.6 inches or more, and a wall thickness of about 0.0055 inches. These dimensions are exemplary only and are not to be considered limiting. The dimensions will be chosen to suit a particular application, for example, to fit a particular fixture and work piece.

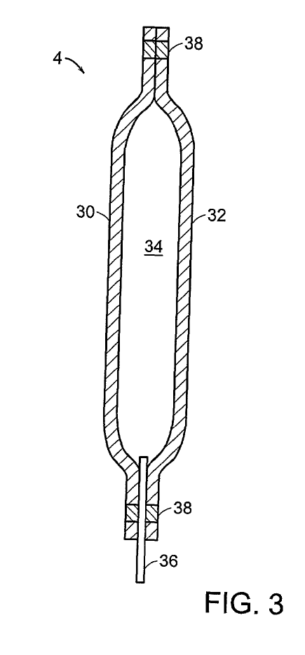

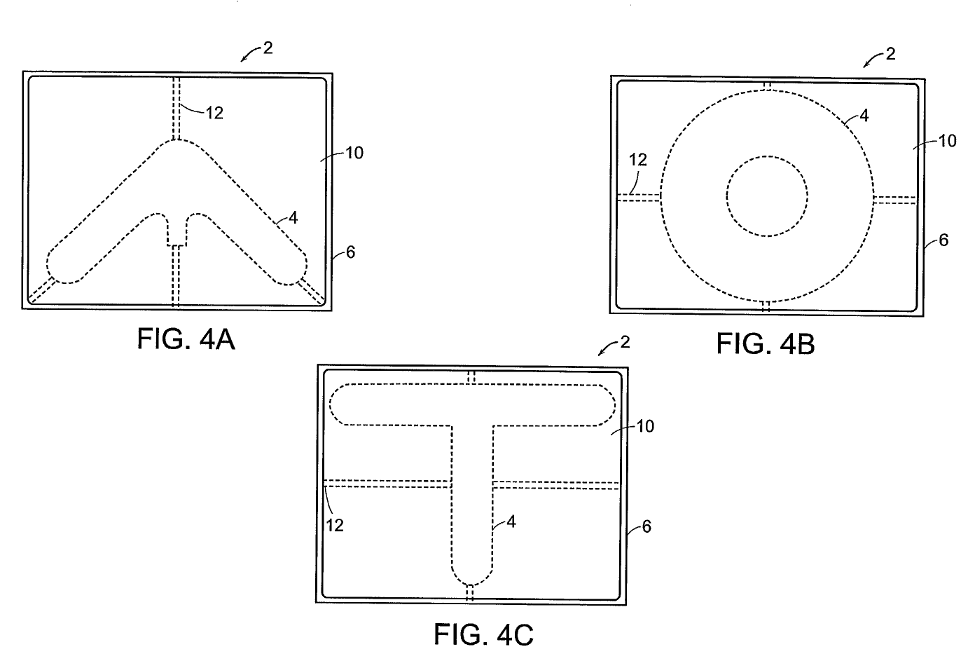

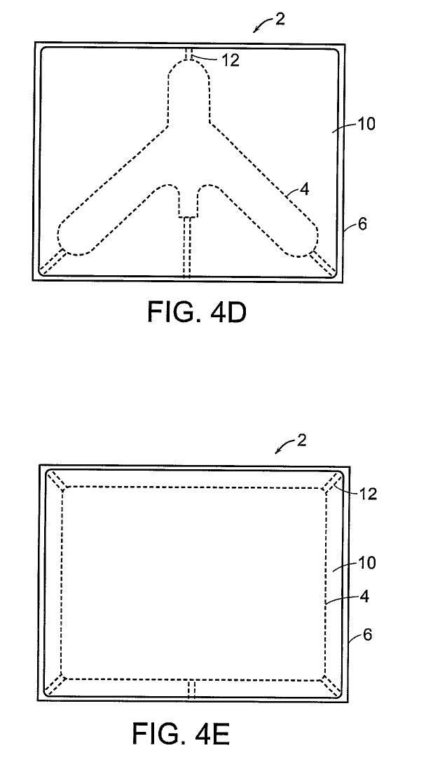

The bladder 4 shown in FIG. 1 has an X-like shape; however, the bladder 4 could be essentially any shape. For example, FIGS. 4A-4E illustrate some examples of possible bladder shapes. FIG. 4A depicts a bladder 4 having a V-like shape. FIG. 4B depicts a bladder 4 having a arcuate shape, specifically an annular shape. FIG. 4C depicts a bladder 4 having a T-like shape. FIG. 4D depicts a bladder 4 having a Y-like shape. FIG. 4E depicts a bladder 4 having a polygonal shape, specifically a rectangular shape. The bladder material could be any of the materials disclosed hereinabove with respect to the enclosure 6. In particular, the material should be fluid impervious to maintain fluid pressure within the bladder 4. Typical bladder pressures are in the range of about 2 psi to about 6 psi; however, these values are exemplary only and are not to be considered limiting. With suitable construction, bladder pressures may be in the range of up to 10 psi to 20 psi or greater. Other possible materials are discussed hereinbelow with respect to FIG. 3.

FIG. 3 depicts a cross-sectional view of one embodiment of a bladder 4 in accordance with the invention. The bladder 4 is formed of a flexible, compliant laminate having at least two layers of material 30, 32, both of which are impermeable to air. An air-tight pocket 34 is formed between the first and second laminate layers 30, 32. Examples of suitable materials, in addition to those materials discussed hereinabove, include a polymer film bonded to a cloth fabric by an adhesive or a molten plastic extruded onto a cloth fabric. The layers 30, 32 are permanently and sealably bonded to one another around the edges of the pocket 34 such that air introduced into the pocket 34 cannot escape through the seams 38 surrounding the pocket 34. Seams 38 may be formed by stitching, or welding or any other suitable means for securely bonding and sealing the first layer 30 to the second layer 32 around the perimeter of the pocket 34. An expansion tube 36 extends between the layers 30, 32 of the bladder 4 and communicates with the interior pocket 34, such that air may be pumped into and released from the pocket 34 during the course of expansion and contraction of the bladder 4. Alternate designs may include a second tube wherein air is pumped into the pocket 34 through the first tube, and released through the second. The bag-like enclosure 6 may be similarly formed.

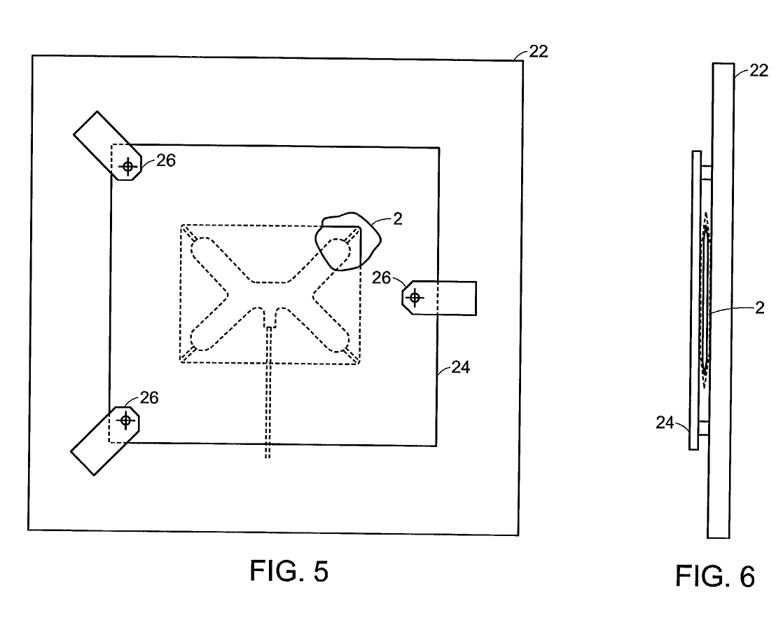

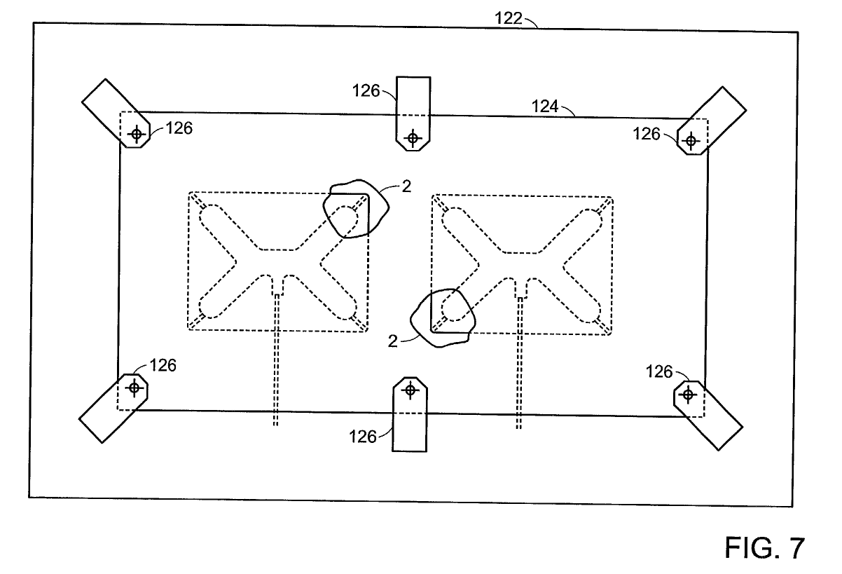

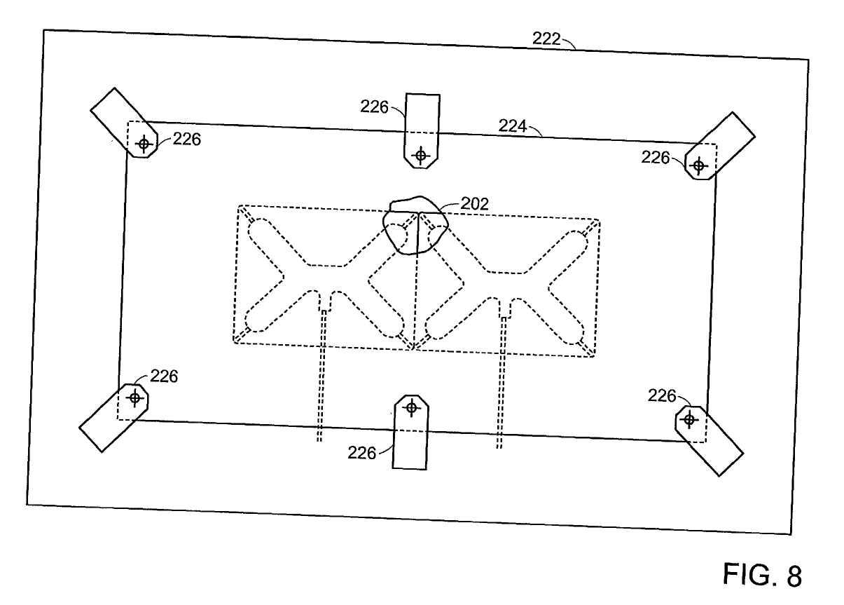

FIG. 5 illustrates a machining fixture 22 with the vibration dampening apparatus 2 of FIG. 1 installed. The apparatus 2 is installed between the fixture 22 and a work piece 24. In the embodiment shown in FIG. 5, the work piece is held in place by a 3-point kinetic mount 26, as is known by those skilled in the art. FIG. 6 is a side view of the installed apparatus 2 shown in FIG. 5. In practice, it is generally desirable to provide a recess in the fixture to seat the apparatus 2. FIG. 7 illustrates another machining fixture 122 with two vibration dampening apparatus 2 installed. FIG. 8 illustrates yet another machining fixture 222 with a multi-compartment vibration dampening apparatus 202 installed.

The operation of the various vibration dampening apparatus 2, 202 is described with respect to FIGS. 5-8. The apparatus 2, 202 is retained in a plate mounted to a vertical plane machining fixture 22. A squeeze bulb, such as those used in sphygmomanometers, is attached to the inner bladder via the tube. By adjusting the pressure in the bladder, the contact pressure between the apparatus 2, 202 and both the fixture 22, 122, 222 and the work piece 24, 124, 224 can be adjusted. This effectively couples the work piece 24, 124, 224 to the fixture 22, 122, 222 to change the natural resonance of the work piece 24, 124, 224, so that the natural resonance can be shifted outside the range excited by the cutting parameters sought to be used. This results in the capability to select more efficient metal removal parameters than otherwise possible, as well as reductions in vibration and chatter and improvement in surface finish. Use of the pressure indicator permits repeatable setups, once optimal conditions are determined. One or more independent or interconnected apparatus 2, 202 could be used, depending on fixture design and work piece configuration.

Having described certain embodiments of the invention, it will be apparent to those of ordinary skill in the art that other embodiments incorporating the concepts disclosed herein can be used without departing from the spirit and the scope of the invention. Accordingly, the described embodiments are to be considered in all respects only as illustrative and not restrictive. Therefore, it is intended that the scope of the present invention be only limited by the following

What is claimed is:

1. An apparatus for dampening vibrations, comprising:
an enclosure containing a gel-like material; and
a bladder disposed within the enclosure.

2. The apparatus of claim 1, wherein the bladder is expandable.

3. The apparatus of claim 2, further comprising an expansion assembly in fluid communication with the bladder.

4. The apparatus of claim 3, wherein the expansion assembly includes a pressure indicator.

5. The apparatus of claim 1, wherein the enclosure is configured to fit within a machining fixture.

6. The apparatus of claim 1, wherein the enclosure is made of flexible material.

7. The apparatus of claim 1, wherein the enclosure shape is selected from the group consisting of polygonal, arcuate, tubular, and combinations thereof.

8. The apparatus of claim 1, wherein the gel-like material is selected from the group consisting of propylene glycol, hydrogel, plasticized polyvinyl chloride, superabsorbant polymer compositions, polyacrylamide, polyols, gelatin, and combinations thereof.

9. The apparatus of claim 1, wherein the bladder shape is selected from the group consisting of X-like, Y-like, T-like, V-like, polygonal, arcuate, and combinations thereof.

10. An apparatus for dampening vibrations, comprising:
an enclosure including at least two compartments, each compartment containing a gellike material; and
a bladder disposed within each of the at least two compartments of the enclosure.

11. The apparatus of claim 10, wherein the bladders are expandable.

12. The apparatus of claim 11, further comprising at least one expansion assembly in fluid communication with the bladders.

13. The apparatus of claim 12, wherein the at least one expansion assembly includes a pressure indicator.

14. The apparatus of claim 10, wherein the enclosure is configured to fit within a machining fixture.

15. The apparatus of claim 10, wherein the enclosure is made of flexible material.

16. The apparatus of claim 10, wherein the enclosure shape is selected from the group consisting of polygonal, arcuate, tubular, and combinations thereof.

17. The apparatus of claim 10, wherein the gel-like material is selected from the group consisting of propylene glycol, hydrogel, plasticized polyvinyl chloride, superabsorbant polymer compositions, polyacrylamide, polyols, gelatin, and combinations thereof.

18. The apparatus of claim 1, wherein the bladder shape is selected from the group consisting of X-like, Y-like, T-like, V-like, polygonal, arcuate, and combinations thereof.

19. A method of attenuating vibration, the method comprising the steps of:
disposing a vibration dampening apparatus in a fixture;
disposing a work piece on the fixture; and
biasing the apparatus against at least a portion of one of the work piece and the fixture to change the frequency characteristics thereof.

20. The method of claim 19, wherein the vibration dampening apparatus includes an enclosure containing a gel-like material and a bladder disposed within the enclosure.

21. The method of claim 20, wherein biasing the apparatus comprises the step of at least one of expanding and contracting the bladder.
